(19) United States
(12) Patent Application Publication
(10) Pub. No.: US 2020/0392814 A1
(43) Pub. Date: Dec. 17, 2020

(54) MODULAR SKID UNIT WITH INTEGRATED FUEL SUPPLY AND RETURN MANIFOLD

(71) Applicant: Schlumberger Technology Corporation, Sugar Land, TX (US)

(72) Inventors: Nick Paul Krippner, Houston, TX (US); Frederick Walker, Houston, TX (US); Kasey Dean Herman, Houston, TX (US)

(21) Appl. No.: 16/438,684

(22) Filed: Jun. 12, 2019

(51) Int. Cl. E21B 41/00

(52) U.S. Cl. CPC E21B 41/0085; F03B 13/02

(57) ABSTRACT

An assembly may include a frame moveable from a first location to a second location, a pipe manifold, and an equipment. The pipe manifold and the equipment may be coupled to the frame. The pipe manifold may include a plurality of valves. The pipe manifold may obtain an amount of fuel from one of the various valves. The valve may be configured to couple with a fuel storage device.

### BACKGROUND

Drilling rigs utilize a lot of power, and because rigs are generally located in remote locations, the power is generated locally. The types of power sources have varied, such as from mechanical, hydraulic, DC/DC, and AC/DC systems. Specifically, engines are coupled to an electric alternating current (AC) or direct current (DC) generator (AC type being most commonly used). As the engine turns (generally fueled by diesel), it rotates the generator. The rotation of the generator results in the “generation” of the voltage and current (power) required to operate the drilling rig. The majority of new rigs are AC/DC electric rigs that use multiple diesel-electric generator sets to produce megawatts of power for the drill site, including drilling equipment, camp loads, etc. As drilling operations have gotten more complicated (deeper, faster, etc.) the number of generator sets has increased, with the number of generators varying with the depth of the drilling and the type of operation. As mentioned, the generators are generally fueled by diesel. The diesel is pumped from a source (such as a storage tank) to the engines by way of a supply and return fuel line, or manifold, and a pump. Manifolds that supply and return fuel are utilized to feed various power generators vary, but many manifolds use lines that are routed on each power generator's skid, or on separate fuel manifold skids.

### SUMMARY

In general, in one aspect, embodiments relate to an assembly that includes a frame moveable from a first location to a second location. The assembly includes a pipe manifold coupled to the frame. The assembly includes an equipment coupled to the frame. The pipe manifold includes a plurality of valves. The pipe manifold obtains an amount of fuel from a valve among the plurality of valves. The valve is configured to couple with a fuel storage device.

In general, in one aspect, embodiments relate to a system that includes a modular skid unit. The modular skid unit includes a pipe manifold. The system includes a power generator coupled to the pipe manifold. The system includes a fuel storage device coupled to the pipe manifold. The pipe manifold transports an amount of fuel from the fuel storage device to the power generator.

In general, in one aspect, embodiments relate to a method that includes connecting a plurality of power generators to a modular skid. The method uses a pipe manifold in the modular skid unit to transmit an amount of fuel to the plurality of power generators from a fuel storage device. The method uses the amount of fluid to generate electric power. The method includes disconnecting at least one power generator among the plurality of power generators from the pipe manifold.

Other aspects of the disclosure will be apparent from the following description and the appended claims.

### BRIEF DESCRIPTION OF DRAWINGS

FIG. 1 shows a block diagram of a system in accordance with one or more embodiments.

FIG. 2 shows a block diagram of a system in accordance with one or more embodiments.

FIG. 3 shows a bottom view of a modular skid unit according to one or more embodiments.

FIG. 4 shows an example in accordance with one or more embodiments.

FIG. 5 shows a flowchart in accordance with one or more embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include methods and systems directed to managing fuel distribution to power generators. In particular, power generators at a drilling rig site may be coupled to a pipe manifold located in a modular skid unit. In contrast to power generators connected in series separately from a modular skid unit, the pipe manifold may provide physical pipe infrastructure to enable a single power generator to be connected or disconnected independently of other power generators connected to the pipe manifold. Likewise, disposing a pipe manifold within the hardware of a modular skid unit may reduce the amount of additional hardware for fueling the power generators from a fuel supply.

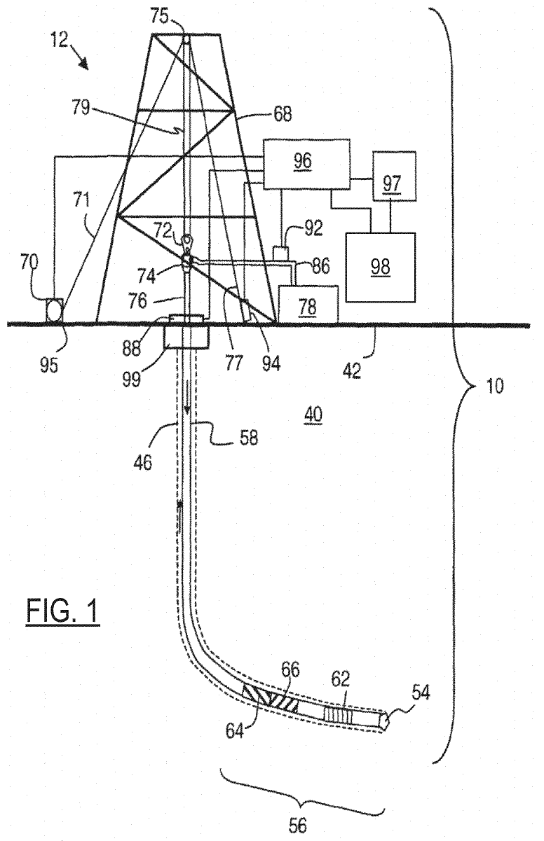

FIG. 1 shows a block diagram of a system in accordance with one or more embodiments. FIG. 1 shows a drilling system (10) according to one or more embodiments having various equipment that are powered during a drilling operation by the generator sets (98) described herein. Drill string (58) is shown within borehole (46). Borehole (46) may be located in the earth (40) having a surface (42). Borehole (46) is shown being cut by the action of drill bit (54). Drill bit (54) may be disposed at the far end of the bottom hole assembly (56) that is attached to and forms the lower portion of drill string (58). Bottom hole assembly (56) may include a number of devices including various subassemblies. Measurement-while-drilling (MWD) subassemblies may be included in subassemblies (62). Examples of MWD measurements may include direction, inclination, survey data, downhole pressure (inside the drill pipe, and/or outside and/or annular pressure), resistivity, density, and porosity. Subassemblies (62) may also include a subassembly for measuring torque and weight on the drill bit (54). The signals from the subassemblies (62) may be processed in a processor (66). After processing, the information from processor (66) may be communicated to pulser assembly (64). Pulser assembly (64) may convert the information from the processor (66) into pressure pulses in the drilling fluid. The pressure pulses may be generated in a particular pattern which represents the data from the subassemblies (62). The pressure pulses may travel upwards though the drilling fluid in the central opening in the drill string and towards the surface system. The subassemblies in the bottom hole assembly (56) may further include a turbine or motor for providing power for rotating and steering drill bit (54).

The drilling rig (12) may include a derrick (68) and hoisting system, a rotating system, and/or a mud circulation system, for example. The hoisting system may suspend the drill string (58) and may include draw works (70), fast line (71), crown block (75), drilling line (79), traveling block and hook (72), swivel (74), and/or deadline (77). The rotating system may include a kelly (76), a rotary table (88), and/or engines (not shown). The rotating system may impart a rotational force on the drill string (58). Likewise, the embodiments shown in FIG. 1 may be applicable to top drive drilling arrangements as well. Although the drilling system (10) is shown being on land, those of skill in the art will recognize that the described embodiments are equally applicable to marine environments as well.

The mud circulation system may pump drilling fluid down an opening in the drill string. The drilling fluid may be called mud, which may be a mixture of water and/or diesel fuel, special clays, and/or other chemicals. The mud may be stored in mud pit (78). The mud may be drawn into mud pumps (not shown), which may pump the mud though stand pipe (86) and into the kelly (76) through swivel (74), which may include a rotating seal. Likewise, the described technologies may also be applicable to underbalanced drilling. If underbalanced drilling is used, at some point prior to entering the drill string, gas may be introduced into the mud using an injection system (not shown).

The mud may pass through drill string (58) and through drill bit (54). As the teeth of the drill bit (54) grind and gouge the earth formation into cuttings, the mud may be ejected out of openings or nozzles in the drill bit (54). These jets of mud may lift the cuttings off the bottom of the hole and away from the drill bit (54), and up towards the surface in the annular space between drill string (58) and the wall of borehole (46).

At the surface, the mud and cuttings may leave the well through a side outlet in blowout preventer (99) and through mud return line (not shown). Blowout preventer (99) comprises a pressure control device and a rotary seal. The mud return line may feed the mud into one or more separator (not shown) which may separate the mud from the cuttings. From the separator, the mud may be returned to mud pit (78) for storage and re-use.

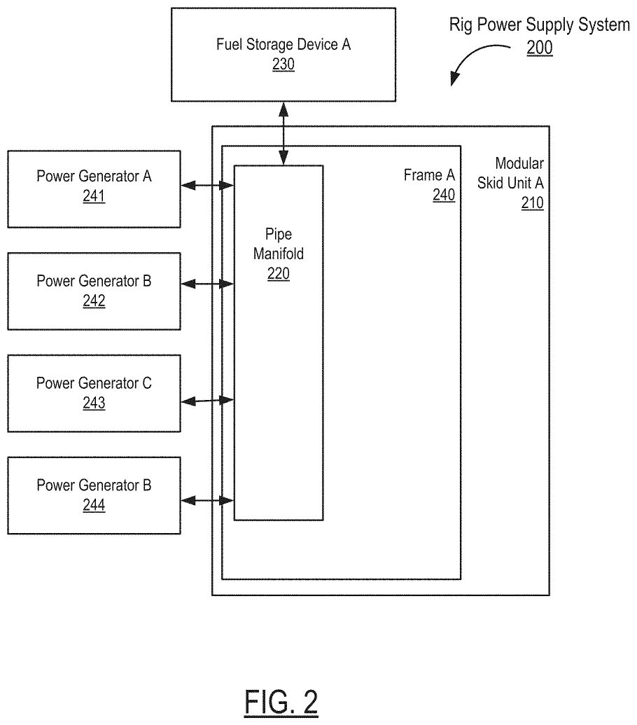

Various sensors may be placed on the drilling rig (12) to take measurements of the drilling equipment. In particular, a hookload may be measured by hookload sensor (94) mounted on deadline (77), block position and the related block velocity may be measured by a block sensor (95) which may be part of the draw works (70). Surface torque may be measured by a sensor on the rotary table (88). Standpipe pressure may be measured by pressure sensor (92), located on standpipe (86). Signals from these measurements may be communicated to a surface processor (96) or other network elements (not shown) disposed around the drilling rig (12). In addition, mud pulses traveling up the drillstring may be detected by pressure sensor (92). For example, pressure sensor (92) may include a transducer that converts the mud pressure into electronic signals. The pressure sensor (92) may be connected to surface processor (96) that converts the signal from the pressure signal into digital form, stores and demodulates the digital signal into useable MWD data. According to various embodiments described above, surface processor (96) may be programmed to automatically detect one or more rig states based on the various input channels described. Processor (96) may be programmed, for example, to carry out an automated event detection as described above. Processor (96) may transmit a particular rig state and/or event detection information to user interface system (97) which may be designed to warn various drilling personnel of events occurring on the rig and/or suggest activity to the drilling personnel to avoid specific events. Generator sets (98) may generate and transmit power to one or more electronic components in the drilling system (10), such as the processor (96) and/or the user interface system (97) as well as one or more mechanical components that utilize electrical power to operate. The generator sets (98) will be described in more detail in FIG. 2.

Turning to FIG. 2, FIG. 2 shows a block diagram of a system in accordance with one or more embodiments. As shown in FIG. 2, a rig power supply system (200) may include a modular skid unit (e.g., modular skid unit A (210)) including a pipe manifold (e.g., pipe manifold (220)), the pipe manifold being coupled to a fuel storage device (e.g., fuel storage device A (230)), and various power generators (e.g., power generator A (241), power generator B (242), power generator C (243), and power generator D (244)). The rig power supply system (200) may include a modular skid unit that may be a structure including hardware with functionality to enclose operational elements modularly. The modular skid unit may include a frame (e.g., frame A (240)) that is hardware that includes the functionality for housing the modular skid unit and transporting the modular skid unit from one location to another. The pipe manifold may be incorporated partially or entirely in the frame and the modular skid unit. The modular skid unit and pipe manifold housed in the frame may be connected to additional modular skid units through skid-to-skid arrangements and cascaded between the various connections in the pipe manifold. These connections may include flexible hoses capable of withstanding various environmental conditions.

The pipe manifold may be hardware that includes functionality to transport fuel between one or more entry points in a modular skid unit to one or more exit points in the modular skid unit. For example, the rig power supply system (200) may be an arrangement including skid-to-skid pipe manifold connections via flex hoses with self-valving quick disconnects for fuel supply and return. In some embodiments, the pipe manifold is mounted in a power control room (PCR) skid unit, which may include one or more control center for power distribution and power processing systems. The PCR skid unit may be configured for controlling power generated by one or more generators for the consumption at the rig site where the rig power supply system (200) is located. In one or more embodiments, the pipe manifold (220) may include an arrangement of piping or various valves designed to control, distribute, and monitor fluid flow through the pipe manifold. Additionally, the pipe manifold (220) may be a common pipe or chamber having several lateral outlets.

In one or more embodiments, the modular skid unit A (210) may be a conveyance, such as a sled with runners or pontoons, used to transport portable equipment to a location, which may have a variety of terrains including marshes or soft, soggy terrain. Additionally, the modular skid unit A (210) may be a steel frame on which the portable equipment is mounted to facilitate handling with cranes or flatbed trucks. The modular skid unit A (210) may be configured with attachment points or hooks, chains, or cables, and may have at least two lengthwise beams to facilitate sliding the equipment into place on the rig site. In one or more embodiments, the modular skid unit A (210) may be a skid structure including at least one area configured to perform one or more tasks directed to a specific service. For example, the modular skid unit A (210) may be a PCR skid unit including equipment directed to controlling and distributing power. Additionally, the modular skid unit A (210) may incorporate at least one area configured for distributing a specific service without including a module that provides the service being distributed throughout a rig site. For example, the modular skid unit may include a small subsection dedicated as a PCR, where the rest of the skid unit is configured to support other rig operations.

In one or more embodiments, the rig power supply system (200) may include a fuel storage device (e.g., fuel storage device (230). A rig fuel storage device may be a tank designed for storing volatile liquids such as diesel or other fuels. The fuel storage device (230) may be a pressure storage tank, or a pressure-type tank, located at a safe distance from a modular skid unit. The fuel storage device (230) may be one or more cylindrical vessels. Some fuel storage devices may support several hundred pounds per square inch of internal pressure. Additionally, the fuel storage device (230) may be an underground fuel storage. For example, in some embodiments, the fuel storage device may be hardware that includes functionality to supply fuel to diesel fuel pumps assembled to distribute fuel to an exterior structure, such as the modular skid unit (210).

In one or more embodiments, the power generator A (241) may be a diesel power generator, including a combination of a diesel engine with an electricity generator or alternator to generate electrical energy. Additionally, the power generator A (241) may be a diesel compression-ignition engine designed to run on diesel fuel, or a generator adapted for other liquid fuels. For example, the power generator A (241) may be hardware implemented in connection with the modular skid unit (210) that includes functionality to supply partially, or entirely, electrical power to one or more modular skid units.

Similarly, the power generator A (241), the power generator B (242), the power generator C (242), and the power generator D (242) may be connected to the pipe manifold (220) in a parallel arrangement, rather than in series, to partially, or entirely supply, power to one or more components at the drilling rig site, including but not limited to those discussed above in FIG. 1. Additionally, the power generators may be arranged to be progressively assembled (over a period of time during a drilling operation) as electrical energy is required in an operation at the rig site. That is to say, a drilling operation may begin with a certain number of power generators and as the power demands change over time (such as with deeper depths or types of operations), additional generators may be assembled to the rig power supply system (200) (and specifically to the manifold) without interrupting rig operations. Similarly, the power generators may be disconnected, e.g., for maintenance operations, as electrical energy requirements are reduced at the rig site. In contrast, in a series-configuration without using a pipe manifold in a modular skid unit, disconnecting one of the power generators may disconnect fuel transport to the rest of the power generators. Thus, a parallel-configuration as shown in FIG. 2 may enable connecting and disconnecting one of the power generators without interfering with the connections of the rest of the power generators to the pipe manifold. In a case where rig is connected to the rig power supply system (200) as backup power source to a power grid, the power generators may be used as an emergency power-supply if the power grid fails.

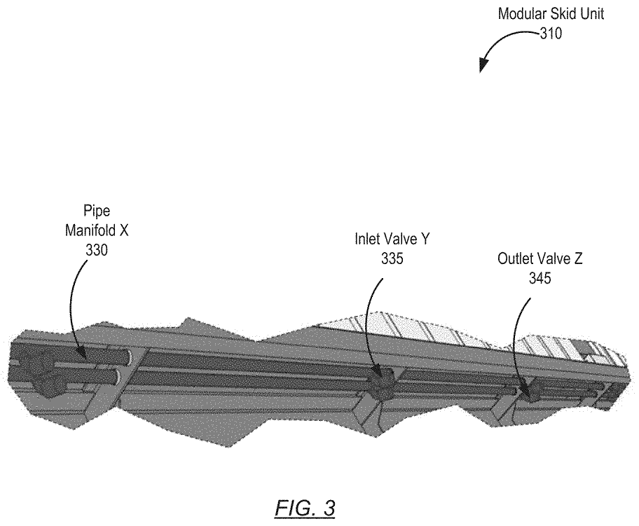

Turning to FIG. 3, FIG. 3 shows a bottom view of a modular skid unit according to one or more embodiments. As shown in FIG. 3, the modular skid unit (310) includes a pipe manifold X (330) arranged underneath. The pipe manifold X (330) may include at least one fuel line and may be coupled with various valves including at least one valve pair (e.g., inlet valve Y (335) and outlet valve Z (345)). For example, the valve pair may include an inlet valve and an outlet valve for supplying fuel and returning fuel. In some embodiments, a number of the valve pairs may be equal to a maximum number of power generators that may be connected to the modular skid unit at any point in time. In one or more embodiments, the number of the valve pairs may be greater than the maximum number of power generators. For example, the power generators may be connected to the modular skid unit at any point in time. As such, the valves that are not used by power generators may be used to transport fuel to other skid units or standalone equipment in the rig site. Moreover, the pipe manifold X (330) may be a manifold that includes various connections to other modular skid units. For example, the pipe manifold X (330) may be hardware including functionality to connect through various valves to another modular skid units, a power generator, or a fuel storage device. For example, by adding another set of valves to the end of the PCR, fuel may be distributed to the other skid units without disrupting primary power generation or having to add another fuel line.

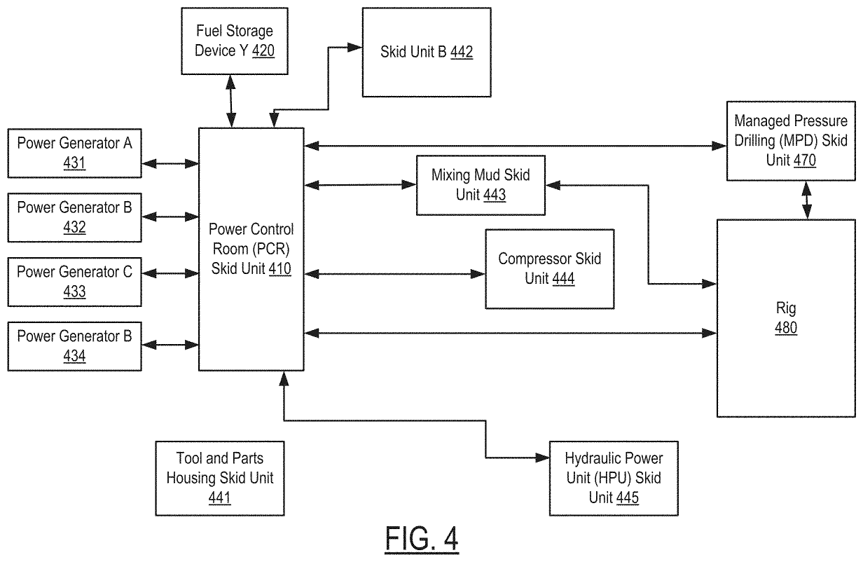

Turning to FIG. 4, FIG. 4 provides an example of a rig site. The following example is for explanatory purposes and not intended to limit the scope of the disclosed technology. Turning to FIG. 4, the rig site may include a rig (480) coupled with various modular skid units (i.e., PCR skid unit (410), fuel storage device Y (420), tools and parts housing skid unit (441), skid unit B (442), mud mixing skid unit (443), compressor skid unit (444), Hydraulic Power Unit (HPU) skid unit (445), managed pressure drilling (MPD) skid unit (470)). The rig site also includes various generators (i.e., power generator A (411), power generator B (412), power generator C (413), power generator D (414)).

In one or more embodiments, the rig (480) may be a drilling rig. The rig (480) may be a system used to drill a wellbore, including but not limited to a rig and rig components described in FIG. 1. In this case, the rig (480) may include the mud tanks, the mud pumps, the derrick or mast, the drawworks, the rotary table or topdrive, the drillstring, and auxiliary equipment. For example, while the systems of the present disclosure may be described for use on a land rig, it is also envisioned that the rig (480) may be an offshore rig. As such, the rig (480) may include the same components as onshore, but not those of a vessel or drilling platform itself.

In one or more embodiments, the PCR skid unit (410) is coupled to the fuel storage device Y (420), to various modular skid units, and to rig (480). As shown, such skid units may be disposed at a distance away from the rig (480). Despite the PCR skid unit (410) being spaced from the rig (480), electrical power used by the rig (480) to perform one or more drilling operations is provided by power generators A to D controlled through PCR skid unit (410). In one or more embodiments, this area on a rig site may designed for storing equipment used in various drilling operations and may be referred to as a backyard. The equipment in the backyard may include elements used for power generation, control, mud storage, and mud pumping. Furthermore, the backyard may include various modular skid units, including but not limited to those described herein, that may be powered by one or more of the power generators described herein. It is also envisioned that during land-based drilling operations, rig (480) may be moved to drill one or more subsequent wells at a pad site while the components in the backyard (including PCD skid unit, power generators, and fuel storage) are not moved. However, due to the modularity of the components, they may be easily transported if moved with the rig.

Keeping with FIG. 4, the tools-and-parts housing skid unit (441) may be a modular skid unit where tools and parts are used and stored in day-to-day operations. The tools and parts housing skid unit (441) may be configured for maintaining and conditioning tools used for operations in a drilling site. Generally, the tools and parts housing skid unit (441) may be disposed in a location near non-hazardous areas. Additionally, the tools and parts housing skid unit (441) may be a housing structure located in an end opposite to an end containing the rig. The tool-and-parts housing skid, to the extent that it utilizes power, may be partially, or totally, powered by one or more of the generators described above.

Turning to the various modular skid units, the skid unit B (442) may be a mud house, or a sack room, where mud additives are kept at the rig site, and mud mixing skid (443) may include one or more hoppers, storage tanks, and/or mixers for mixing a drilling fluid to be pumped downhole by mud pumps. Additionally, the skid unit B (442) and mud mixing skid (443) may each be a modular skid unit located at a safe distance from the rig. The skid unit B (442) may include housing including various mud pumps used for well drilling. For example, in some embodiments, the skid unit B (442) and mud mixing skid (443) may include hardware that includes functionality to provide services relating to mud treatment and processing. In one or more embodiments, the skid unit B (442) may be a water tank, cement processing skid unit, or a modular skid unit as described above. As such, the skid unit B (442) and mud mixing skid unit (443) may be an area for processing mud and/or cement. The skid unit B (442) and mud mixing skid unit (443) may be used in direct coupling with the PCR skid unit (410), and using power generated from power generators A to D. Furthermore, the mud mixing skid unit (443) may be a mud blending skid unit located closer to the PCR skid unit (410) than the fuel storage device Y (420).

In one or more embodiments, the compressor skid unit (444) may be a modular skid assembled to include a compressor that is partially, or totally, powered by one or more of the generators described above. The compressor skid unit (444) may include a device that raises the pressure of air or natural gas. In this case, the compressor skid unit (444) may use positive displacement to compress the gas to higher pressures so that the gas may flow into pipelines and other facilities. Displacement may be an offset of segments or points that were once continuous or adjacent. Additionally, the compressor skid unit (444) may be a facility including of various compressors, auxiliary treatment equipment and pipeline installations to pump natural gas under pressure over long distances. A compressor plant may be called a compressor station. Several compressor stations may be used in modular skid units to re-pressurize gas in large interstate gas pipelines or to link offshore gas fields to their final terminals.

In one or more embodiments, the HPU skid unit (445) may be a modular skid unit assembled to include a device used in a hydraulic system to store energy or, in some applications, dampen pressure fluctuations. The hydraulic system may be partially, or totally, powered by one or more of the generators described above. The HPU skid unit (445) may store energy by compressing a pre-charged gas bladder with hydraulic fluid from an operating or charging system. For example, in some embodiments, the HPU skid unit (445) may be coupled with the modular skid unit (210).

In one or more embodiments, the MPD skid unit (270) may be modular skid unit in which equipment controls an adaptive drilling method used to control the annular pressure throughout a wellbore. The MPD skid unit (270) may be partially, or totally, powered by one or more of the generators described above Additionally, the MPD skid unit (270) may be a modular skid unit that utilizes a variety of techniques including control of back pressure, adjusting mud density, modifying fluid rheology, adjusting the annular fluid level, controlling circulating friction and incorporating hole geometry in the well construction. For example, the MPD skid unit (270) may be hardware including the functionality to control the risks and costs of drilling wells with narrow downhole pressure limits by actively managing the wellbore pressure profile has become a common practice. The MPD skid unit (270) may be disposed between a power source and the rig.

In one or more embodiments, fuel may be transported from the PCR skid unit (410) to one or more skids, including but not limited to those described herein. For example, the tools and parts housing skid unit (441) may include a portable generator that may be powered by transporting fuel from the PCR skid unit (410). Furthermore, for example, fuel may be transported from the PCR skid unit (410) to the mud mixing skid unit (443). At the mud mixing skid unit (443), fuel, such as diesel, may be blended or mixed with one or more other components to form an oil-based mud to achieve certain mud properties required for specific drilling conditions. As such, the pipe manifold may also serve as a means of distributing fuel to other auxiliary skids or services.

In one or more embodiments, by routing the fuel lines on both sides of the PCR, more points to tap into and supply fuel to other skid units may be added. Such arrangement may permit uninterrupted operation of the main power generation systems as well as minimize the number of separate fuel lines that have to be routed.

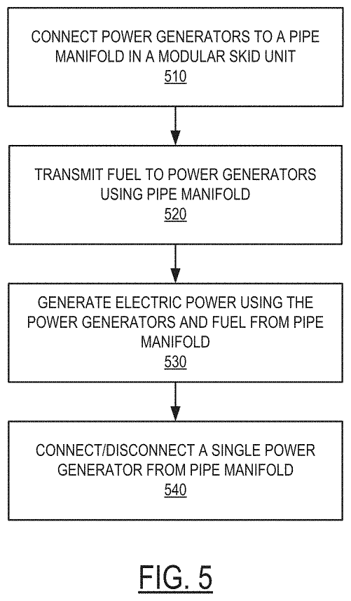

Turning to FIG. 5, FIG. 5 shows a flowchart in accordance with one or more embodiments. Specifically, FIG. 5 describes a method for using power generators in combination with modular skid units. One or more blocks in FIG. 5 may be performed by one or more components as described above in FIGS. 1-4. While the various blocks in FIG. 5 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 510, various power generators are connected to a pipe manifold in a modular skid unit in accordance with one or more embodiments. For example, the power generators may be connected to a pipe manifold through one of the valve pairs. In particular, the power generators may be arranged in parallel to the pipe manifold, which may prevent fuel supply from being cut off from the rest of the power generators when a generator is not connected.

In some embodiments, a drilling profile determines the ratings and quantities of power generators for a specific operation or project. Furthermore, the drilling profile is based on a worst-case drilling condition. As such, the quantities of power generators utilized are determined based on their power capacity and output capabilities. Since worst-case conditions are used to determine total power requirements, most drilling rigs are designed and rigged up with more power generators than necessary. As such, during regular operation of the rig, connecting and disconnecting engines may be difficult. Connections made when pumping fuel could result in accidental shutdown of operating engines, rig blackout, or environmentally unsound and unsafe fuel spillage.

In Block 520, fuel is transmitted to various power generators using a pipe manifold in accordance with one or more embodiments. For example, a fuel storage device may be assembled at a first end of a pipe manifold and power generators may be assembled at a second end or along a length of the pipe manifold. This arrangement may allow fuel to travel from the fuel storage device to the power generators by using the pipe manifold.

In Block 530, electric power is generated using various power generators and fuel from a pipe manifold in accordance to one or more embodiments. For example, power generators may require diesel fuel to start and supply electrical energy to additional modular skid units.

In Block 540, a single power generator is connected or disconnected from the pipe manifold in accordance to one or more embodiments. In such event, fuel distribution is not interrupted to the rest of the power generators coupled to the pipe manifold. For example, power generators arranged in parallel may not be affected if one out of various power generators are added, replaced or packaged away. Since the power generators are connected in parallel, supply and return fuel lines of the power generators are routed in a separate skid and pre-manufactured with similar connections as covered above. As such, this method permits uninterrupted operations in an event when one of the various power generators happen to be serviced or replaced. When connected in series, should one of the power generators closest to the fuel source fail, downstream power generators may be shut down before the upstream power generator can be removed. If one of the downstream power generators is left operating while disconnecting the upstream power generator, risk of shutting the downstream power generators and fuel spillage increases due to pressurized fuel lines and fuel pressure variations. As such, unless the rig is at a state where one power generator is required, productivity may decrease when power generators are connected in series.

In one or more embodiments, the method described in FIG. 5 may be used for improving scheduling of power generators required for a specific well site or drilling profile, and permitting continuous operations without having to shutdown drilling to add or remove a generator. Additionally, the aforementioned techniques for transporting fuel improve maintenance programs, decrease fuel costs, reduce cost for engine/generator packaging, and increase safety. For example, the method as described in FIG. 5 may reduce transportation costs if a power generator is not required at the time of drilling, then the generator may be left at storage or lay down yard, or the generator may ship to another rig site that may need another generator.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. An assembly, comprising:
a frame moveable from a first location to a second location;
a pipe manifold coupled to the frame, the pipe manifold comprising a plurality of valves; and
an equipment coupled to the frame,
wherein the pipe manifold obtains a first amount of fuel from a valve among the plurality of valves, and
wherein the valve is configured to couple with a fuel storage device.

2. The assembly of claim 1, further comprising:
connections for coupling to a rig, the rig being movable from a first well at the first location to a second well at the second location.

3. The assembly of claim 1, wherein the plurality of valves comprise an inlet valve and an outlet valve.

4. The assembly of claim 1, wherein the plurality of valves supplies the first amount of fuel to a first power generator coupled to the pipe manifold.

5. The assembly of claim 1, wherein the plurality of valves supply a second amount of fuel to a second power generator coupled to the pipe manifold.

6. The assembly of claim 1, wherein the equipment is drilling equipment that performs one or more drilling operations at a rig.

7. A system, comprising:
a modular skid unit comprising a pipe manifold;
a first power generator coupled to the pipe manifold; and
a fuel storage device coupled to the pipe manifold,
wherein the pipe manifold transports a first amount of fuel from the fuel storage device to the first power generator.

8. The system of claim 7, further comprising:
a second power generator coupled to the pipe manifold,
wherein the second power generator and the first power generator are coupled to the pipe manifold in parallel with respect to the pipe manifold, and
wherein the pipe manifold transports a second amount of fuel from the fuel storage device to the second power generator.

9. The system of claim 7, wherein the modular skid unit is coupled to a rig, the rig being movable from a first well to a second well.

10. The system of claim 7,
wherein the first power generator is connected to the pipe manifold using a plurality of valves, and
wherein the plurality of valves comprise an inlet valve and an outlet valve.

11. The system of claim 10, wherein a number of valve pairs equals a number of power generators connected in parallel with respect to the pipe manifold.

12. The system of claim 7, wherein the modular skid unit is a power control room (PCR) skid unit.

13. The system of claim 7, further comprising:
a mud mixing skid unit coupled to the modular skid unit,
wherein the pipe manifold further transports fuel from the fuel storage device to the mud mixing skid unit.

14. A method, comprising:
connecting a plurality of power generators to a modular skid unit;
transmitting, using a pipe manifold in the modular skid unit, an amount of fuel to the plurality of power generators from a fuel storage device;
generating electric power using the amount of fuel; and
disconnecting at least one power generator among the plurality of power generators from the pipe manifold.

15. The method of claim 14, wherein the modular skid unit connects to the plurality of power generators using a pipe manifold.

16. The method of claim 14, wherein the pipe manifold transports the amount of fuel from a fuel storage device to the at least one power generator.

17. The method of claim 14, wherein the plurality of power generators are connected to the pipe manifold through a plurality of respective valves.

18. The method of claim 17, wherein the plurality of valves comprise an inlet valve and an outlet valve.

19. The method of claim 14, wherein the modular skid unit is a power control room (PCR) skid unit.

20. The method of claim 14, wherein the modular skid unit is coupled to a rig, the rig being movable from a first well to a second well.
